(19) United States
(12) Patent Application Publication
(10) Pub. No.: US 2025/0202780 A1
(43) Pub. Date: Jun. 19, 2025

(54) UNIFIED CONTENT MANAGEMENT AND CONTROL SYSTEM

(71) Applicant: Elizabeth BUCKLEY, Washington, DC (US)

(72) Inventor: Elizabeth BUCKLEY, Washington, DC (US)

(21) Appl. No.: 18/539,050

(22) Filed: Dec. 13, 2023

(51) Int. Cl. H04L 41/22

(52) U.S. Cl. CPC H04L 41/22

(57) ABSTRACT

The disclosure relates to systems, methods, and computer-readable media for unified content management and control. A method includes establishing, by a content management and control platform, a connection with a user device, where the content management and control platform is configured to communicate with the user device and a plurality of platforms, receiving, by the content management and control platform, a user request from the user device to initiate a client session on a first platform of the plurality of platforms, where the client session is configured to transmit communications between the user device and a client device through the first platform, initiating, by the content management and control platform, the client session on the first platform, and causing, by the content management and control platform, the user device to display a user interface, where the user interface displays the client session to a user of the user device.

### TECHNICAL FIELD

The present technology relates to a unified content management and control system and, more particularly to, a unified content management and control system configured to provide a user secure access to communicate with a client device through a client session on a third-party platform.

### BACKGROUND

Technology for generating, producing, and providing content is experiencing rapid growth, such that the technology is becoming more accessible to individual consumers and users. For example, cameras have become commonplace on mobile devices and the quality of such cameras has improved significantly. As another example, the emergence of more alternatives for content editing software has provided the masses opportunities for easily improving their digital assets, such as photos and videos. As yet another example, many companies have developed platforms that allow users to independently post their content onto the platform(s), which provides the general public better distribution and visibility of their content.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example environment having a user device interacting with a content management and control platform according to some aspects of the disclosed technology.

FIG. 2 illustrates an example content management and control platform according to some aspects of the disclosed technology.

FIG. 3A illustrates an example user interface according to some aspects of the disclosed technology.

FIG. 3B illustrates an example user interface according to some aspects of the disclosed technology.

FIG. 3C illustrates an example user interface according to some aspects of the disclosed technology.

FIG. 3D illustrates an example user interface according to some aspects of the disclosed technology.

FIG. 3E illustrates an example user interface according to some aspects of the disclosed technology.

FIG. 4 illustrates an example method securely initiating a client session on a first platform between a user device and a client device according to some aspects of the present technology.

FIG. 5 illustrates an example of a deep learning neural network according to some aspects of the disclosed technology.

FIG. 6 shows an example of a system for implementing certain aspects of the present technology.

### DETAILED DESCRIPTION

Technology for generating, producing, and providing content is experiencing rapid growth, such that the technology is becoming more accessible to individual consumers and users. For example, cameras have become commonplace on mobile devices and the quality of such cameras has improved significantly. As another example, the emergence of more alternatives for content editing software has provided the masses opportunities for easily improving their digital assets, such as photos and videos. As yet another example, many companies have developed platforms that allow users to independently post their content onto the platform(s), which provides the general public better distribution and visibility of their content.

Despite these positive impacts, the ease of access to generating, editing, and distributing content creates new problems and challenges. For example, with such a large number of platforms, users can lose track of what content has been posted to which platform(s). Additionally, it is time consuming and inefficient for users to individually upload content to each of these platforms.

This is further exacerbated by private transmittals of content. For example, some content creators provide content to a particular client only after the client has paid for the content. As such, the content creator may lose track of which content has been sent to which client(s) through which platform(s) and, consequently, any metrics that may be of interest to the content creator (e.g., revenue that content generates, number of purchases, etc.). Additionally, these metrics may not be aggregated and adequately tracked across the large number of platforms. The lack of data that these metrics provide can reduce efficiency and overall profitability for content creators.

The use of such technology to distribute such content also generates problems and challenges. While the barrier to entry for content creation has been vastly lowered, education regarding cybersecurity and privacy has not kept pace. Many users are unaware of the totality of data that they are uploading to the Internet.

Activities performed on digital devices connected to the Internet leave behind traces of data. For example, these traces of data are left behind when a user utilizes a digital service, and/or when information about the user is published onto a digital forum or platform, such as a social network or content sharing platform. These traces of data are also referred to as digital dust and/or a digital footprint.

Since the digital footprint is publicly left behind, these traces of data can be collected, stored, analyzed, and even sold to other entities. Consequently, digital footprints put privacy and even security at risk. Hackers, stalkers, and other malicious actors are able to use personal information gathered online to answer security challenge questions, determine where users live, predict how people might interact, and perform many other undesirable actions. In malicious instances, the leaking of sensitive information can result in substantial dangers to the users. For example, stalkers may determine where users live or otherwise frequent and physically go to such a location. In other words, the dangers and invasion of privacy generated by digital dust can produce dangers and privacy violations in the real world.

Cybersecurity is often overlooked. While individual users have access to all these different software and devices, the users may not recognize potential security concerns that arise from distribution of content. For example, digital photos taken on phones often have tags that identify the location of the photo, the time the photo was captured, type of device, operating system, and/or software used to capture the photo, etc. In other words, the users may not be aware of the metadata that may be included in a particular digital asset. Consequently the users may unknowingly transmit sensitive information and leave behind digital dust that allow bad actors to access such sensitive information.

As another example, users are increasingly engaging with live streaming, which is when a video is being taken in real time and sent over the internet to viewers and/or clients. The video stream may include a source Internet Protocol (IP) address of the video stream, which can provide insight into a location of the user in real time.

As yet another example, Internet chat rooms and similar platforms allow users to chat and otherwise interact in real-time. Some bad actors may send links that, when clicked by a user, track and capture data of the user's device. For example, tracking links can log when a click was made, the IP address of the user device, the type and/or operating system of the user device, the content that the user is later redirected to (e.g., to determine interests of the user), etc.

The present technology provides solutions for a unified content management and control system. The content management and control system of the present disclosure provides a unified experience to access a plurality of third party platforms, so that content creators have a singular system to track and interact with the plurality of third party platforms. The content management and control system also provides visualizations and security settings to provide important information that can improve efficiency, profitability, security, and privacy of content creators in an easily digestible manner. For example, the content management and control platform can generate user interfaces that include visualizations for metrics tracked across assets, platforms, clients, and transactions. Additionally, the user interfaces can be configured to allow efficient access to content for sharing with filters based on metadata, to stay organized and keep track of the statuses of the many assets that content creators generate.

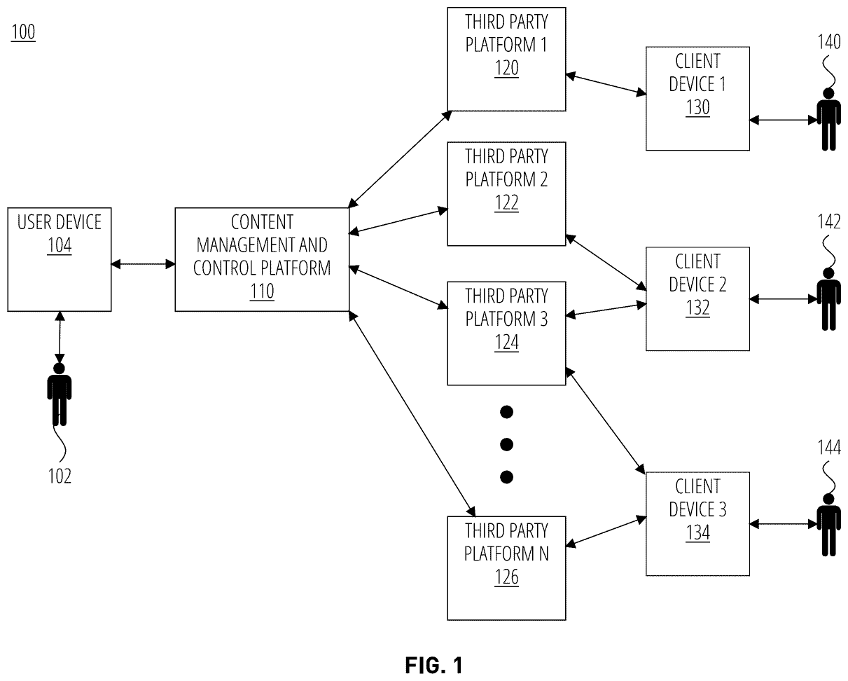

Turning now to the figures, FIG. 1 illustrates an example environment 100 having a user 102 using a user device 104 to access a content management and control platform 110, which is configured to communicate with one or more third party platforms 120-126 that one or more clients 140-144 may be accessing through respective client devices 130-134, a client device 132.

Users 102 can utilize user devices 104. User devices 104 can be a terminal, a computer, a server, a mobile device, a tablet, a cellphone, or any other suitable device capable of communicating with or otherwise accessing content management and control platform 110. In some instances, user devices 104 can include one or more sensors to capture data. For example, user devices 104 can include a camera, a video camera, a webcam, a virtual reality (VR) camera, a microphone, etc. These sensors can capture pictures, videos, audio, and other types of assets that can be used for content.

As will be discussed in further detail below, the content management and control platform 110 is configured to provide users 102 a convenient, unified, and secure platform to access various third party platforms 120-126. As illustrated in FIG. 1, content management and control platform 110 is configured to communicate with or otherwise access one or more third party platforms 120-126. For example, content management and control platform 110 can include access credentials for the accounts of the user 102 of the third party platform 120-126 that the user has an account for.

Third party platforms 120-126 can be any social media, content sharing platform, file hosting platform, content subscription services, monetization platforms for content, live streaming platform, video streaming websites, video hosting service, messaging application or service, etc. Some examples of such third party platforms 120-126 include many platforms from Facebook, Instagram, YouTube, and Pornhub to Twitch, TikTok, OnlyFans, and Snapchat. In some instances, third party platforms 120-126 can have application programming interfaces (APIs) that are configured to permit content management and control platform 110 to communicate with or otherwise access the third party platforms 120-126 and/or vice versa. As illustrated in FIG. 1, third party platforms 120-126 can be accessed by one or more client devices 130-134. For example, the clients 140-144 may have an account for one or more of the third party platforms 120-126.

Clients 140-144 can use respective client devices 130-134 to access third party platforms 120-126. Like user devices 104, client devices 130-134 can be a terminal, computer, a server, a mobile device, a tablet, a cellphone, or any other suitable device capable of communicating with or otherwise accessing third party platforms 120-126. As illustrated in FIG. 1, the client devices 130-134 can access one or more of the third party platforms 120-126. Similar to user devices 104, client devices 130-134 can also include one or more sensors to capture pictures, videos, audio, and other types of assets.

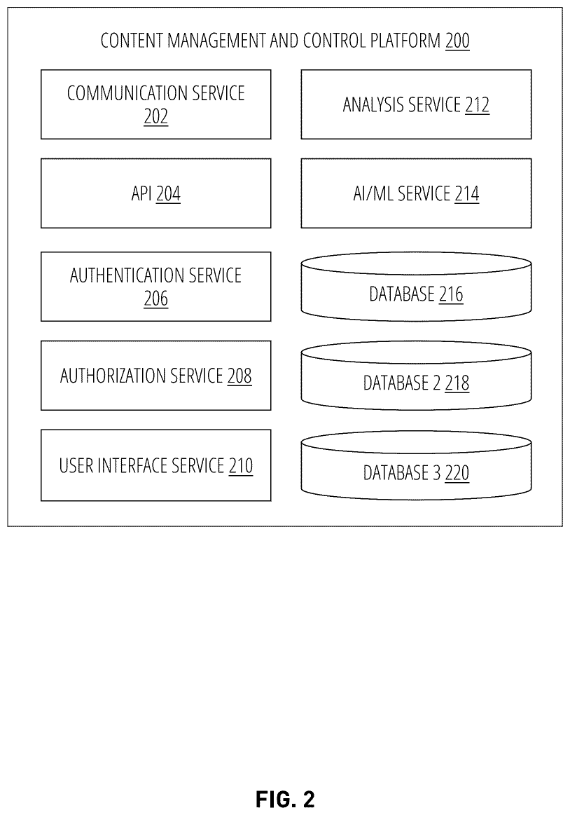

FIG. 2 illustrates an example content management and control platform 200. The content management and control platform 200 can include a communication service 202, an API 204, an authentication service 206, an authorization service 208, a user interface service 210, an analysis service 212, an artificial intelligence and/or machine learning (AI/ML) service 214, a database 216, a database 218, and a database 220. In some instances, content management and control platform 200 and/or parts thereof can be hosted on a cloud service and utilize authentication services, authorization services, token procedures, and other benefits of the cloud service.

Communication service 202 can include both software and hardware elements for transmitting and receiving signals from/to other entities such as user devices 104, third party platforms 120-126, client devices 130-134, etc. The communication service 202 is configured to transmit information through the Internet to communicate with such entities. In some instances, communication service 202 is configured to access virtual private networks (VPNs) to reroute an Internet Protocol (IP) address of the user device 104 and/or the content management and control platform 200. In some instances, communication service 202 can provide content to clients 140-144 (e.g., directly to their respective client devices 130-134 and/or through a third party platform). In some instances, communication service 202 can be configured to remove metadata in or otherwise associated with content prior to sending, transmitting, or otherwise providing the content to the clients 140-144.

API 204 is an interface for two or more entities to communicate with each other. More specifically, API 204 can be configured to allow communications between content management and control platform 200 (e.g., via communication service 202) and user devices 104, third party platforms 120-126, and/or client devices 130-134. For example, API 204 can be configured to receive and process login requests by the user 102 from the user device 104. As another example, API 204 can be configured to send login requests to the third party platforms 120-126.

Authentication service 206 is configured to authenticate user 102. Authentication service 206 can receive login request data from user device 104 (e.g., via communication service 202 and/or API 204) and authenticate the user 102 on the content management and control platform 200 based on the login request data. For example, authentication service 206 may access a database of accounts registered with content management and control platform 200 and determine whether credentials of the login request data match at least one entry. In some instances, authentication service 206 can also facilitate authentication of the user 102 on the third party platforms 120-126. For example, authentication service 206 can send login request data to the third party platforms 120-126 (e.g., via communication service 202 and/or API 204) and determine whether the user 102 has been authenticated by the third party platforms 120-126. As another example, the authentication service 206 can be configured to receive user account credentials from the user device and, based on the user account credentials, authenticate the user account on multiple third party platforms 120-126. One of ordinary skill in the art would understand that the present technology can be modified using the many different methods for performing and facilitating authentication of the user 102.

Authorization service 208 is configured to determine whether user 102 is authorized to utilize content management and control platform 200. In some instances, authorization service 208 determines whether an account of user 102 has paid for a subscription for a service and/or whether a subscription for a service is active. In some instances, authorization service 208 collects data associated with an account of the user 102 and matches an identifier of the account with entries in a database (e.g., database 216-220) to determine whether the user is authorized to access the service.

User interface service 210 is configured to generate user interfaces that can be displayed on user devices 104. For example, user interface service 210 can generate user interfaces that present metrics, video, pictures, content, digital assets, etc. As will be discussed in further detail below, user interface service 210 can generate user interfaces that display a wide variety of information, data, and content. More specifically, the user interface provides a central location to access multiple third party platforms 120-126 and keep track of the status of various content and/or digital assets. Additionally, the user interface service 210 can generate a user interface that displays analytics generated based on data and metadata associated with usage of the user device 104 (e.g., as determined using analysis service 212).

Analysis service 212 is configured to receive data and analyze the data. More specifically, analysis service 212 can communicate with databases 216-220 to retrieve data stored therein. Analysis service 212 can then perform analyses pertaining to retrieved (e.g., from databases 216-220) and/or received data (e.g., from user devices 104, third party platforms 120-126, client devices 130-134, etc. For example, analysis service 212 can retrieve, from a database 216, historical data associated with client sessions between a user 102 (e.g., via user device 104) and a client 140 (e.g., via client device 130) and determine metrics and/or trends based on the historical data. For example, analysis service 212 can retrieve historical transactions for a particular video and determine a metric, such as total revenue generated by the particular video, and/or a trend, such as time periods during which the particular video is purchased more frequently.

AI/ML service 214 provides the infrastructure for training, evaluating, and/or deploying machine learning models. Using the AI/ML service 214, data scientists can prepare data sets from databases 216-220; select, design, and train machine learning models; evaluate, refine, and deploy the models; maintain, monitor, and retrain the models; etc.

In some instances, analysis service 212 can utilize machine learning models trained and/or deployed by AI/ML service 214 to perform analyses. In some instances, machine learning models may be configured to identify trends and/or metrics without explicit instructions thereto. For example, a user may not know that different content generates more revenue and does not track this metric. Despite not being explicitly instructed to determine content that generates more revenue, a machine learning model of analysis service 212 can determine that a particular photo generates more revenue and identify or otherwise inform the user that the particular photo generates more revenue than other content.

Databases 216-220 are configured to store a wide variety of data. For example, databases 216-220 are configured to store data associated with user accounts, client accounts, digital assets, videos, pictures, other content, historical transaction data between user accounts and client accounts (e.g., purchases of content, subscriptions of the user account by the client account, etc.), historical session data between user accounts and client accounts (e.g., time and duration, IP addresses, locations, etc.), usage of virtual private networks (VPNs), connected accounts of users (e.g., accounts of the users on another platform), data associated with providing content, data associated with live streaming, etc.

Content management and control platform 200 can be configured with one or more databases 216-220. Each database can be configured to store different types of data. For example, database 216 may be configured to store videos, pictures, and other content associated with user accounts, while database 218 is configured to store user account credentials and database 220 is configured to store historical transaction data and session data between user accounts and client accounts. In some instances, one or more databases are relational databases.

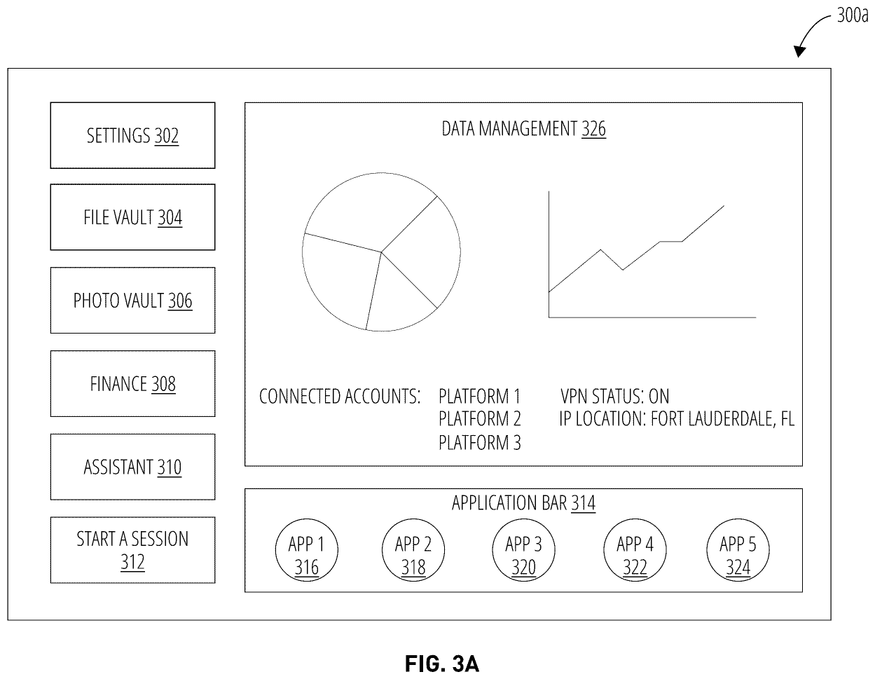

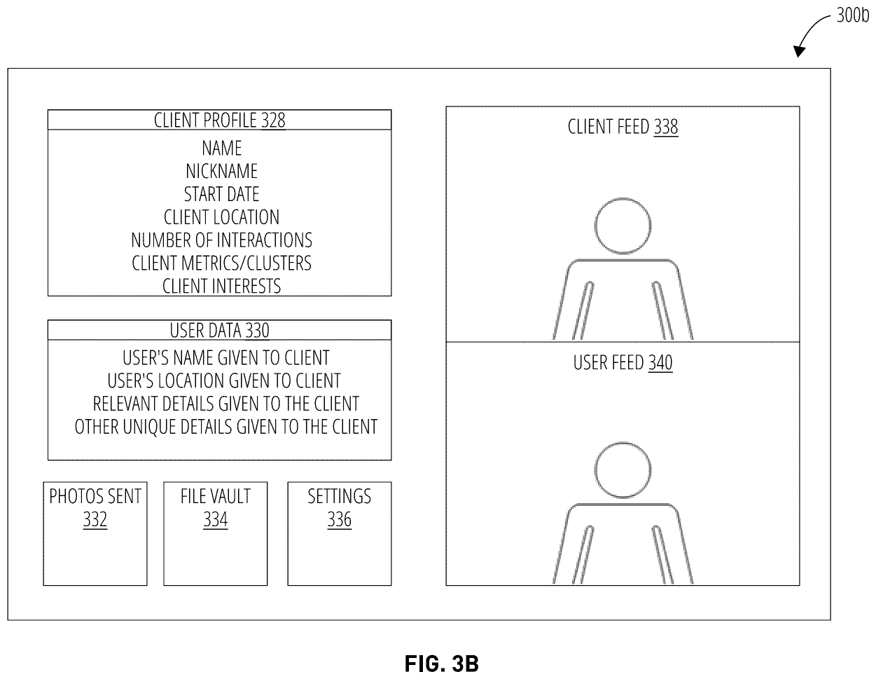

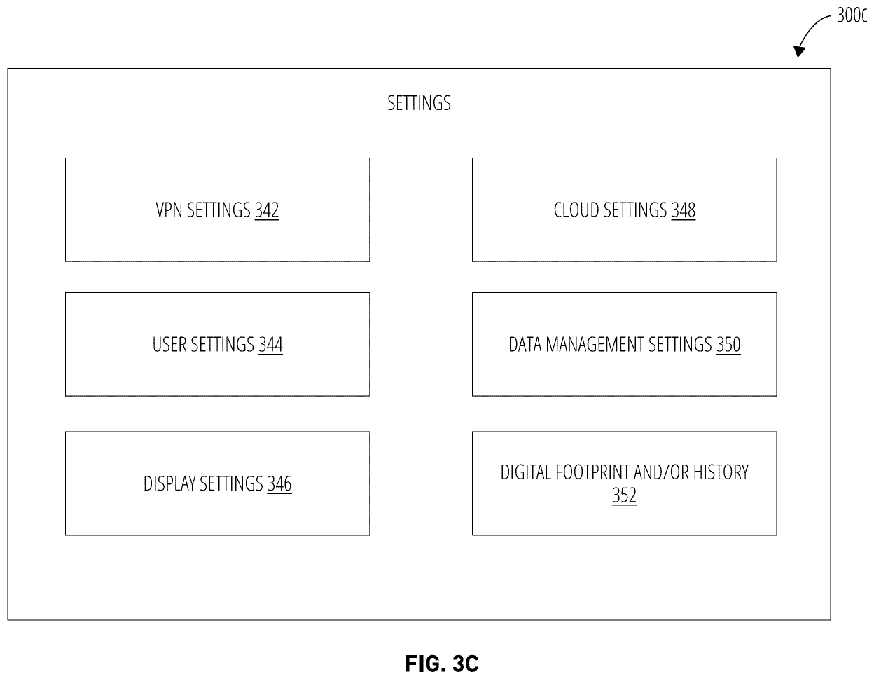

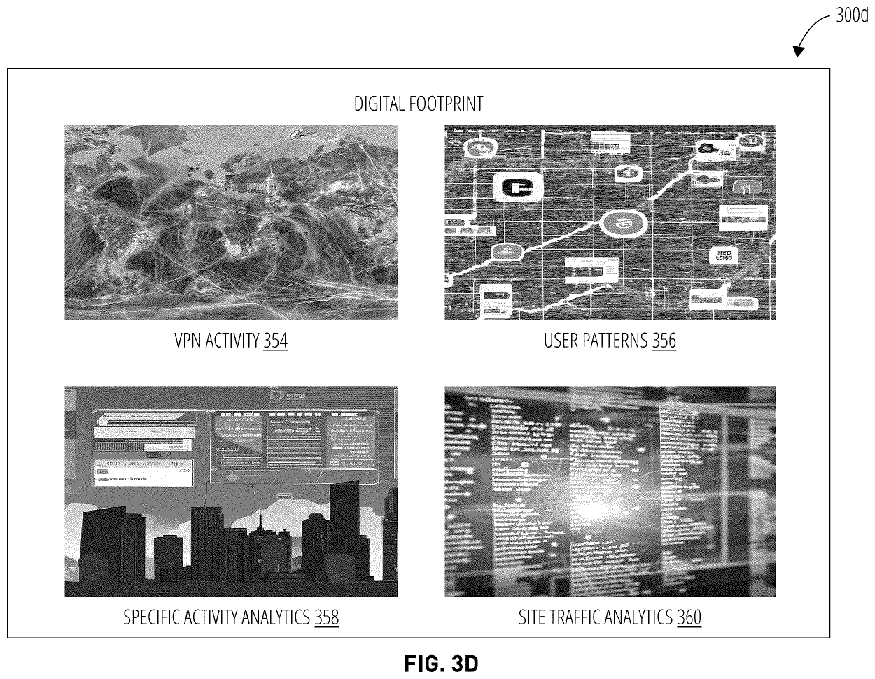

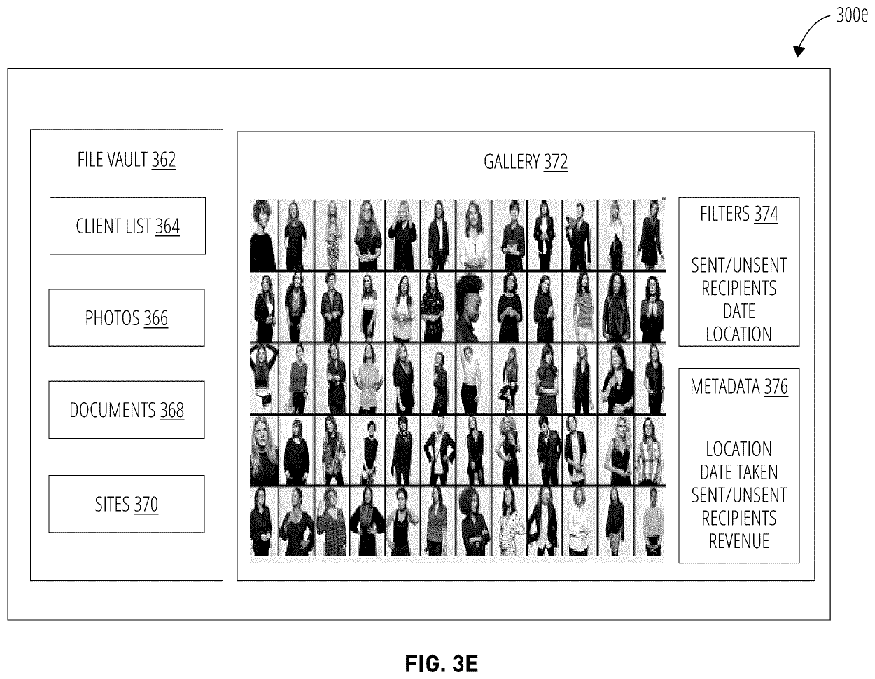

As discussed above, content management and control platform 200 can include a user interface service 210 that can generate user interfaces for display on user devices. FIG. 3A-FIG. 3E illustrate various example user interfaces generated by content management and control platform 200 (e.g., using user interface service 210) that a user device may display to a user. It is to be understood that the example user interfaces described below are for discussion and explanatory purposes only. One of ordinary skill in the art would understand that the modifications and customization of the provided example user interfaces are within the scope of the present disclosure.

FIG. 3A illustrates an example user interface 300a. The user interface 300a can display links 302-312, an application bar 314, and a display area for data management 326.

Links 302-312 provide simple navigation to various functionalities that content management and control platform 200 provides. For example, link 302 directs the user to a settings page, link 304 directs the user to a file vault, link 306 directs the user to a photo vault, link 308 directs the user to a finance page, link 310 directs the user to an assistant, and link 312 directs the user to start a client session (e.g., a session between a user account of the user and a client account of a client).

For example, link 308 directs the user to a finance page, which can include or otherwise provide access to various financial data and functionalities. For example, the finance page display and provide access to the user's bank accounts, payment processing services that the user utilizes, investment accounts of the user, etc. In some instances, the finance page provides access to a plurality of different financially related platforms, such that the finance page acts as a single sign-on location that authenticates across multiple applications and/or websites.

Application bar 314 provides additional ease of access to various different applications 316-324. Application bar 314 can be customized based on applications 316-324 that the user more frequently accesses and/or prefers. Applications 316-324 can include applications and/or services of third party platforms 120-126, such as the examples provided above.

The display area for data management 326 provides a customizable area for visualizing various types of data. For example, FIG. 3A illustrates that the display area for data management 326 can present platforms having connected accounts, charts, metrics, trends, location information, connectivity information, and VPN status, among others.

FIG. 3B illustrates an example user interface 300b displaying a session between a user and a client. When a user clicks the start a session link 312, content management and control platform 200 connects user device 104 with a client device (e.g., client device 130-134) through a third party platform (e.g., third party platform 120-126) and subsequently causes user device 104 to display user interface 300b. For example, the user may choose to initiate a client session on a live video chat service with a client (e.g., in response to a client request). A camera and/or other sensor of user device 104 can capture the user 102 or any other content or object that the user 102 desires. The captured data can be sent in real-time through content management and control platform 200 and a selected third party platform to the client device. Similarly, a webcam of the client device can capture data that the client desires to share and the client device can send the captured data in real-time to the user.

User interface 300b can display a client profile 328, a user data 330, button 332-336, a client feed 338, and a user feed 340.

Client profile 328 provides an area for users 102 to easily access information about the client(s) that the user 102 is currently engaged in a client session with. Client profile 328 can be configured and/or customized to provide different types of information. For example, FIG. 3B illustrates the client profile 328 including a name of the client, a nickname that the user 102 previously gave to the client, the first date of interaction between the user 102 and the client, the location of the client, number of interactions between the user 102 and the client, client metrics (e.g., total amount of money spent on services of the user 102, advertising identifiers, advertising clusters, etc.), and client interests, among others. In some instances, the information displayed can be sourced from third party services. For example, content management and control platform 200 can leverage (e.g., via communication service 202, API 204, and/or analysis service 212) advertising services to determine advertising clusters that clients are associated with and display (e.g., via user interface service 210) the advertising clusters that are associated with the particular client of the client session.

User data 330 provides an area for user 102 to easily access information about the user that the user 102 provided to the particular client of the client session. User data 330 can be configured and/or customized to provide different types of information. In some instances, users 102 may provide clients with non-factual information. For example, users 102 may tell clients that they are named something other than their actual name, that the user lives in a location that the user does not actually live in, etc. In some instances, users 102 may provide clients with specific or unique details that the user 102 does not or has not yet provided to all clients. For example, a user 102 may tell a particular client 140 that is in the client session about a personal experience, which the user 102 has not told other clients 142, 144. Accordingly, FIG. 3B illustrates that the user data 330 area can include the user's name that the user previously gave to the client in the client session, the user's location that the user previously gave to the client, other relevant and/or unique details given to the client, etc. User data 330 provides easy access and organization to information previously provided by the user 102 to the particular client, so that the user 102 can tailor experiences and content to the client.

Buttons 332-button 336 can be configured to access other information. For example, button 332 allows the user 102 to access photos that the user 102 previously sent to the client. Button 334 directs the user 102 to a vault including files for transmittal, such as photos, videos, audio, and/or other content that the user may want to provide to a client. Button 336 allows the user to quickly access different settings, so that the user 102 can easily control and/or manage data that the user device 104 is transmitting.

Client feed 338 displays the data that the client device is transmitting to the user device 104 (e.g., through the selected third party platform and/or the content management and control platform 200). For example, client feed 338 can be a live video stream of the client captured by a webcam connected to or otherwise in communication with the client device.

User feed 340 displays the data that the user device 104 is transmitting to the client device(s). For example, user feed 340 can be a live video stream of the user captured by a webcam connected to or otherwise in communication with the user device 104.

FIG. 3C illustrates an example user interface 300c. User interface 300c can display various settings including VPN settings 342, user settings 344, display settings 346, cloud settings 348, data management settings 350, and digital footprint and/or history 352.

VPN settings 342 allow the users 102 to manually configure VPNs. For example, a user 102 can decide to set their VPN to utilize a specific IP address.

User settings 344 can include connected accounts, account security settings, username, passwords, personal information, etc.

Display settings 346 allow users 102 to manually configure the layout of the user interface, data displayed, resolution of camera feeds, etc.

Cloud settings 348 can be modified by users 102 to configure the cloud environment(s) the users 102 are connected to (e.g., as tenants).

Data management settings 350 include controlling and manipulating metadata for assets, manipulating upload/download speeds, selecting metrics of interest, etc.

Digital footprint and/or history 352 provides insight into the data and/or metadata that is left behind when users 102 connected to content management and control platform 200, platforms 120-126, client devices 130-134, etc.

FIG. 3D illustrates an example user interface 300d, which presents digital footprint and/or history 352 of the user 102. The digital footprint and/or history 352 can include VPN activity 354, user patterns 356, specific activity analytics 358, and site traffic analytics 360. User interface 300d provides users 102 with an easily digestible visualization of data and metadata that is being left behind during interactions with content management and control platform 200, platforms 120-126, client devices 130-134, etc.

VPN activity 354 can identify usage of VPNs, how VPNs were set (e.g., VPN settings 342), location history of VPNs over time, etc. User patterns 356 provides a visualization of an overall picture of any data and/or meta that they have left behind broken down by website, applications, traffic, cookies, etc. Specific activity analytics 358 allows users 102 to view detailed analyses of specific pings or actions. Site traffic analytics 360 presents a browsing history and various metrics of website usage.

FIG. 3E illustrates an example user interface 300e that presents files, photos, documents, videos, and other content that users 102 may want to share with clients 140-144 and access to clients 140-144 that the users 102 may want to share a file, photo, document, video, and/or other content to. For example, user interface 300e can display a file vault 362, which can include a client list 364, photos 366, documents 368, and sites 370, and a gallery 372, which can include filters 374 metadata 376 (e.g., for assets displayed in the gallery 372). File vault 362 presents a client list 364, photos 366, documents 368, and sites 370 for easy and organized access.

Client list 364 can be a database, such as a relational database, that interacts with sessions. The client list 364 can include client data, session data, and other client-specific data as discussed above. Photos 366 can also be a database, such as a relational database, that contains all photos sent to clients tagged with dates, sent status tags, and other metadata. Documents 368 can include legal documents, corporate documents, non-disclosure agreements, statements of work, employment agreements, etc. Sites 370 can include all site and/or application information for sites and/or applications that the user 102 uses to upload content and/or otherwise interacts with.

The gallery 372 displays the various types of assets (e.g., photos, videos, audio, etc.) that the user 102 has uploaded. Gallery 372 can include filters 374, to facilitate efficient and organized searching of assets. For example, filters 374 can filter selections in gallery 372 by metadata 376. Additionally, gallery 372 can present metadata 376 associated with the assets. For example, the metadata 376 can include (e.g., as tags) whether an asset was sent, who the asset was sent to, when the asset was first captured and/or uploaded, when the asset was sent to clients, where the asset was captured, etc.

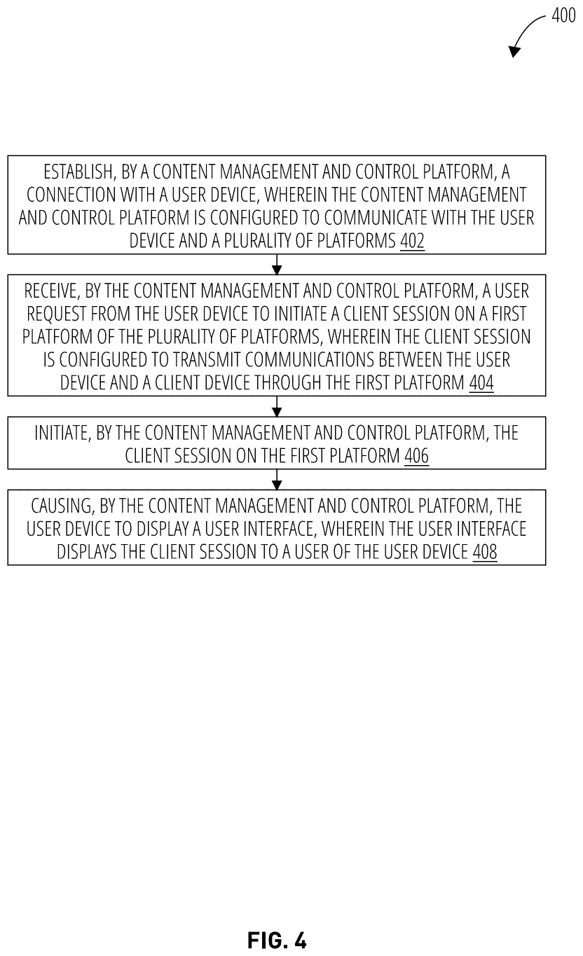

FIG. 4 illustrates an example method 400 for securely initiating a client session on a first platform between a user device and a client device. Method 400 facilitates a unified experience for content management and control. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

In step 402, method 400 establishes, by a content management and control platform, a connection with a user device, wherein the content management and control platform is configured to communicate with the user device and a plurality of platforms. For example, a content management and control platform 200 that is configured to communicate (e.g., via communication service 202 and/or API 204) with a user device 104 and a plurality of platforms 120-126 can establish a connection with the user device 104. As another example, the user device 104 can connect to content management and control platform 200 (e.g., by logging into a service provided by content management and control platform 200).

In step 404, method 400 receives, by the content management and control platform, a user request from the user device to initiate a client session on a first platform of the plurality of platforms, wherein the client session is configured to transmit communications between the user device and a client device 130 through the first platform. For example, content management and control platform 200 receives a user request from the user device 104 to initiate a client session on a first platform 120 of the plurality of platforms 120-126, wherein the client session is configured to transmit and/or otherwise permit communications between the user device 104 and the client device 130.

In some instances, method 400 authenticates, by the content management and control platform, the user 102 with the first platform 120. For example, content management and control platform 200 can utilize communication service 202, API 204, and/or authentication service 206 to authenticate the user 102 with the first platform 120.

In some instances, method 400 determines, based on historical data, an IP address associated with a geographical location. In some instances, the historical data includes a geographical location that the user previously provided to a client associated with the client device 130 of the client session. For example, the user may have previously told the client that the user lived in Fort Lauderdale, which can be saved in a database 216 as historical data. Accordingly, the content management and control platform 200 can determine an IP address associated with Fort Lauderdale based on historical data indicating that the client was previously told that the user lived in Fort Lauderdale.

In some instances, method 400 determines, by the content management and control platform, client session settings, wherein the client session is initiated based on the client session settings. For example, content management and control platform 200 can determine client session settings (e.g., as stored in a database 216).

In step 406, method 400 initiates, by the content management and control platform, the client session on the first platform. For example, content management and control platform 200 can initiate the client session on the first platform 120. In some instances, the client session is initiated through the IP address associated with the geographical location. In some instances, a VPN is used to spoof an IP address of the user device 104 and/or content management and control platform 200 to the IP address associated with the geographical location. In some instances, the client session includes a second client device, wherein the client session is further configured to transmit additional communications between the user device and the second client device.

In step 408, method 400 causes, by the content management and control platform, the user device to display a user interface, wherein the user interface displays the client session to a user of the user device. For example, content management and control platform 200 can generate a user interface 300b (e.g., using user interface service 210) and cause the user device 104 (e.g., by sending user interface 300b to the user device 104 via communication service 202 and/or 204) to display the user interface 300b to the user 102. In some instances, the user interface can include links to a gallery, wherein the gallery is configured to display metadata for each asset in the gallery. For example, user interface 300b includes buttons 332, 334 that direct the user 102 to a page having a file vault 362 and/or gallery 372 of photos or other media presented in the user interface 300e, which also includes an area configured to display metadata 376 for each asset in the file vault 362 and/or gallery 372. In some instances, the metadata 376 includes at least one tag indicating whether each asset in the file vault 362 and/or gallery 372 has been sent to the client device 130.

In some instances, method 400 removes, by the content management and control platform and before sending at least one asset, metadata from the at least one asset. For example, content management and control platform 200 can remove metadata 376 from the at least one asset prior to sending the at least one asset.

In some instances, method 400 sends, by the content management and control platform and based on a selection by the user of the user device, at least one asset stored in at least one database of the content management and control platform to the client device through the client session on the first platform. For example, content management and control platform 200 can send, based on a selection by the user 102 of the user device 104, at least one asset (e.g., photo, video, audio, etc.) stored in at least one database 216 of the content management and control platform 200 to the client device 130 through the client session on the first platform 120.

In some instances, method 400 determines, by the content management and control platform, a historical trend of generated revenue associated with sending the at least one asset to a plurality of historical client devices. For example, content management and control platform 200 can determine (e.g., using analysis service 212 and/or AI/ML service 214) a historical trend of generated revenue associated with sending the at least one asset to a plurality of historical client devices. In some instances, the content management and control platform 200 includes a machine learning model and the machine learning model determines the historical trend.

In some instances, method 400 determines, by the content management and control platform and based on the historical trend, that at least one asset generates revenue above a threshold. For example, content management and control platform 200 can determine (e.g., via analysis service 212 and/or AI/ML service 214) that at least one asset generates revenue above a threshold. In some instances, the threshold can be determined or selected based on an average revenue generated by assets of the user 102.

In some instances, method 400 notifies, by the content management and control platform, the user that the at least one asset generates revenue above the threshold. For example, content management and control platform 200 can notify (e.g., via communication service 202 and/or API 204) the user 102 (e.g., on a user interface displayed on user device 104) that the at least one asset generates revenue above the threshold.

In some instances, method 400 collects, by the content management and control platform, a digital footprint of the user device. For example, content management and control platform 200 can collect, record, and/or store a digital footprint of the user device 104 (e.g., comprised of data received from the user device 104).

In some instances, method 400 causes, by the content management and control platform, display of metrics and/or analytics of the digital footprint of the user in a user interface on the user device. For example, content management and control platform 200 can perform analyses of data of the digital footprint and provide metrics and/or analytics of the digital footprint of the user 102 and cause display (e.g., via communication service 202 and/or API 204) of the metrics and/or analytics in a user interface (e.g., as generated by user interface service 210) on the user device 104.

In some instances, method 400 stores, by the content management and control platform and in at least one database, client session data, wherein the client session data includes a client identity associated with the client device. For example, content management and control platform 200 can store, in at least one database 216, client session data including a client identity associated with the client device 130.

In some instances, method 400 generates, by the content management and control platform and based on the client session data, a client profile. In some instances, the client profile includes a client-specific user identity, wherein the client-specific user identity is an identity of the user that the user provided to a client associated with the client device. For example, content management and control platform 200 can generate a client profile 328 based on the client session data.

In some instances, method 400 receives, by the content management and control platform, client analytics for a client associated with the client device. For example, content management and control platform 200 can receive client analytics for a client 140 associated with the client device 130. In some instances, the client analytics includes advertising clusters determined by a third party.

In some instances, method 400 causes, by the content management and control platform, the user device to display the client analytics in a user interface displayed on the user device. For example, content management and control platform 200 can cause the user device 104 to display the client analytics in a user interface (e.g., as generated by user interface service 210) displayed on the user device 104.

In some instances, method 400 receives, by the content management and control platform from the user device, commands for an artificial intelligence (AI) assistant of the content management and control platform. For example, content management and control platform 200 receives commands for an AI assistant (e.g., as deployed by AI/ML service 214).

In some instances, method 400 generates, by the AI assistant of the content management and control platform, metrics based on the commands. For example, content management and control platform 200 can use AI/ML service 214 to generate metrics based on the commands.

In some instances, method 400 causes, by the content management and control platform, the user device to display the metrics in a user interface displayed on the user device. For example, content management and control platform 200 can cause the user device 104 to display the metrics in a user interface (e.g., as generated by user interface service 210) displayed on the user device 104.

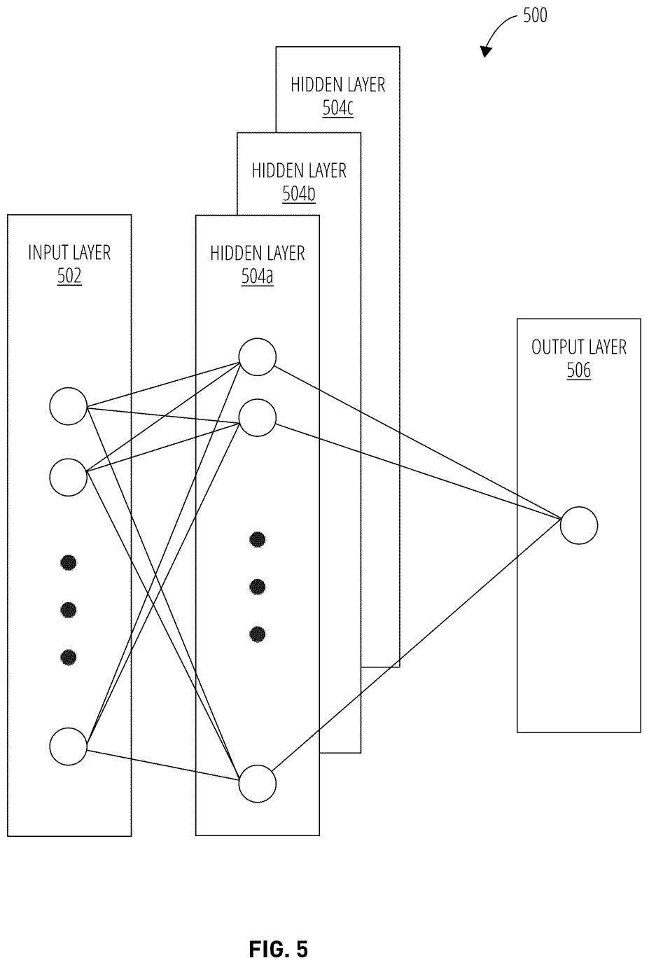

In FIG. 5, the disclosure now turns to a further discussion of models that can be used through the environments and techniques described herein. An input layer 502 can be configured to receive sensor data and/or data relating to digital assets and metadata associated thereto. The neural network 500 includes multiple hidden layers 504a, 504b, through 504c. The hidden layers 504a through 504c include “n” number of hidden layers, where “n” is an integer greater than or equal to one. The number of hidden layers can be made to include as many layers as needed for the given application. The neural network 500 further includes an output layer 506 that provides an output resulting from the processing performed by the hidden layers 504a through 504c. In one illustrative example, the output layer 506 can provide revenue trends across digital assets, that can be used to identify valuable digital assets.

The neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 502 can activate a set of nodes in the first hidden layer 504a. For example, as shown, each of the input nodes of the input layer 502 is connected to each of the nodes of the first hidden layer 504a. The nodes of the first hidden layer 504a can transform the information of each input node by applying activation functions to the input node information. The information derived from the transformation can then be passed to and can activate the nodes of the next hidden layer 504b, which can perform their own designated functions. Example functions include convolutional, up-sampling, data transformation, and/or any other suitable functions. The output of the hidden layer 504b can then activate nodes of the next hidden layer, and so on. The output of the last hidden layer 504c can activate one or more nodes of the output layer 506, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 502 using the different hidden layers 504a through 504c in order to provide the output through the output layer 506.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

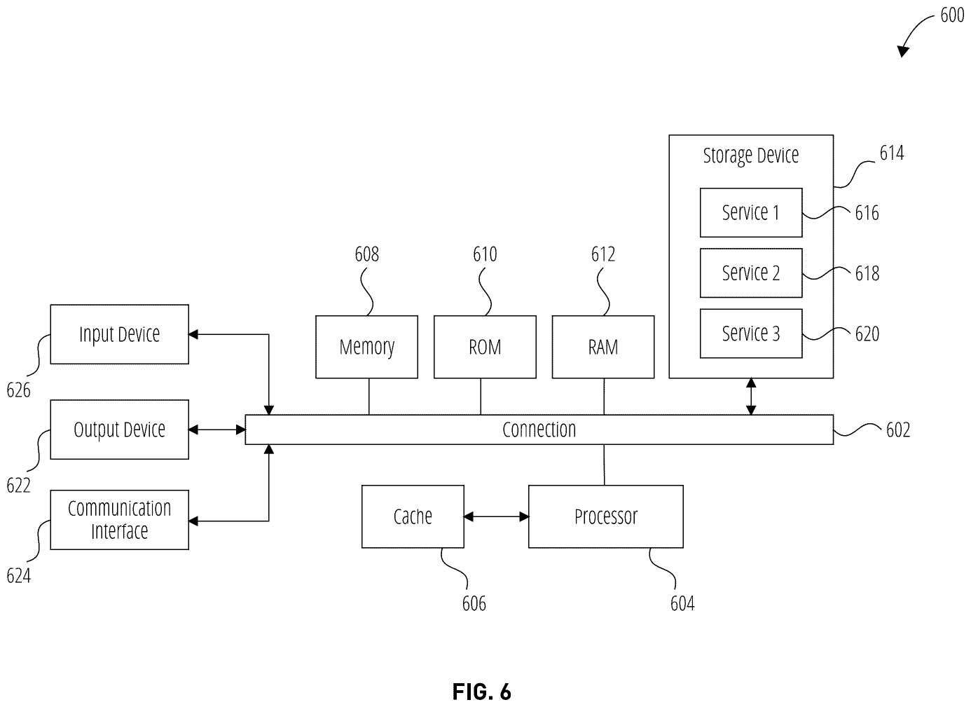

FIG. 6 shows an example of computing system 600, which can be for example any computing device making up user device 104, content management and control platform 110, third party platforms 120-126, client devices 130-134, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 608, such as read-only memory (ROM) 610 and random access memory (RAM) 612 to processor 604. Computing system 600 can include a cache of high-speed memory 606 connected directly with, in close proximity to, or integrated as part of processor 604.

Processor 604 can include any general purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

1. A method comprising:
establishing, by a content management and control platform, a connection with a user device, wherein the content management and control platform is configured to communicate with the user device and a plurality of platforms;
receiving, by the content management and control platform, a user request from the user device to initiate a client session on a first platform of the plurality of platforms, wherein the client session is configured to transmit communications between the user device and a client device through the first platform;
initiating, by the content management and control platform, the client session on the first platform;
determine metrics or trends based on the historical data associated with client sessions between the user and the client;
causing, by the content management and control platform, the user device to display a user interface, wherein the user interface displays the client session to a user of the user device;
storing, by the content management and control platform in at least one database, client session data;
wherein the client session data includes a client identity associated with the client device;
wherein the client session is a session between a user account of the user and a client account of a client.

2. The method of claim 1, further comprising:
determining, based on historical data residing in the client session database, an Internet Protocol (IP) address associated with a geographical location,
and wherein the client session is initiated through the IP address associated with the geographical location.

3. The method of claim 2, wherein a virtual private network (VPN) spoofs an IP address of the user device to the IP address associated with the geographical location.

4. The method of claim 1, further comprising:
authenticating, by the content management and control platform, the user with the first platform.

5. The method of claim 1, further comprising:
sending, by the content management and control platform and based on a selection by the user, at least one asset stored in at least one database of the content management and control platform to the client device through the client session on the first platform.

6. The method of claim 5, further comprising:
removing, by the content management and control platform and before sending the at least one asset, metadata from the at least one asset.

7. The method of claim 1, wherein the user interface includes links to a gallery, wherein the gallery is configured to display metadata for each asset in the gallery.

8. The method of claim 7, wherein the metadata includes at least one tag indicating whether each asset has been sent to the client device.

9. The method of claim 7, wherein the metadata includes generated revenue associated with each asset.

10. The method of claim 1, further comprising:
determining, by the content management and control platform, a historical trend of generated revenue associated with sending at least one asset to a plurality of historical client devices.

11. The method of claim 10, wherein the content management and control platform includes a machine learning model, and wherein the machine learning model determines the historical trend.

12. The method of claim 10, further comprising:
determining, by the content management and control platform and based on the historical trend, that the at least one asset generates revenue above a threshold; and
notifying, by the content management and control platform, the user that the at least one asset generates revenue above the threshold.

13. The method of claim 1, further comprising:
collecting, by the content management and control platform, a digital footprint of the user device; and
causing, by the content management and control platform, display of analytics of the digital footprint of the user in the user interface on the user device.

14. The method of claim 1, further comprising:
identifying, by the content management and control platform, the client profile in the client session data database, and
synchronizing, by the content management and control platform, the history of the client profile through the plurality of platforms.

15. The method of claim 14, wherein the client profile includes a client-specific user identity, wherein the client-specific user identity is an identity of the user that the user provided to a client associated with the client device.

16. The method of claim 1, wherein the client session includes a second client device, wherein the client session is further configured to transmit additional communications between the user device and the second client device.

17. The method of claim 1, further comprising:
determining, by the content management and control platform, client session settings, wherein the client session is initiated based on the client session settings.

18. The method of claim 1, further comprising:
receiving, by the content management and control platform, client analytics for a client associated with the client device; and
causing, by the content management and control platform, the user device to display the client analytics in the user interface displayed on the user device.

19. The method of claim 1, further comprising:
utilizing machine learning models trained or deployed by an AI/ML service to perform analysis;
configuring machine learning models to identify trends or metrics without explicit instructions thereto; and
determining that a particular photo generates more revenue and inform the user that the particular photo generates more revenue than other content.

20. A content management and control platform comprising:
a first database storing assets received from a user device;
a communication service configured to communicate with the user device and a plurality of third party platforms, wherein the communication service is configured to receive the assets from the user device and store the assets in the first database, and wherein the communication service is configured to provide the assets to a client device associated with at least one of the plurality of third party platforms;
an authentication service configured to receive user account credentials for a user account from the user device and, based on the user account credentials, authenticate the user account on the plurality of third party platforms;
a client profile generated by the content management and control platform based on client session data;
a second database storing data, client session data, and metadata associated with usage of the user device with the plurality of third party platforms; and
a user interface service configured to generate a user interface that displays analytics generated based on the data and the metadata;
wherein client session data includes a client identity associated with the client device, location of the client, and a list of assets sent to the client by the user;
wherein the client session is a session between a user account of the user and a client account of a client.

21. The method of claim 1, further comprising:
generating, by the content management and control platform and based on client session data, a client profile.

22. The method of claim 1, further comprising:
displaying in the user interface, an easily access information about the user that the user provided to the particular client of the client session.
